(19) United States
(12) Patent Application Publication
(10) Pub. No.: US 2024/0324622 A1
(43) Pub. Date: Oct. 3, 2024

(54) SUGARLESS POPPING CANDY AND PREPARATION METHOD THEREOF

(71) Applicant: GUANGDONG QINGYUNSHAN PHARMACEUTICAL CO., LTD., Shaoguan (CN)

(72) Inventor: Congcong SI, Shaoguan (CN)

(21) Appl. No.: 18/538,033

(22) Filed: Dec. 13, 2023

Related U.S. Application Data
(63) Continuation of application No. PCT/CN2023/085158, filed on Mar. 30, 2023.

(51) Int. Cl. A23G 3/38; A23G 3/36; A23G 3/48

(52) U.S. Cl. CPC A23G 3/38; A23G 3/362; A23G 3/48

(57) ABSTRACT

A sugarless popping candy includes the following components by mass percentage: 40%-79% of isomaltitol; 20%-40% of refined sugarless polyglucose; 0.5%-0.7% of carbon dioxide; 0%-20% of maltitol; and 0%-1.0% of additive.

### CROSS-REFERENCE TO RELATED APPLICATION

This application is a continuation of international PCT application serial no. PCT/CN2023/085158, filed on Mar. 30, 2023. The entirety of PCT application serial no. PCT/CN2023/085158 is hereby incorporated by reference herein and made a part of this specification.

### FIELD OF THE INVENTION

The present application relates to the field of food technology, in particular to a sugarless popping candy and a preparation method thereof.

### DESCRIPTION OF RELATED ART

Popping candy is an innovative candy. When making the popping candy, high-pressure carbon dioxide gas is injected to the hot syrup, and small high-pressure bubbles of high-pressure carbon dioxide gas are formed in the candy. After the candy block cools down, the pressure is released, and the candy block will shatter, but the shattered candy still contain high-pressure bubbles. Because of the addition of compressed carbon dioxide to the candy, when the candy block is placed in the mouth, the candy melts and the carbon dioxide rushes out, causing particles to crackle on the tongue.

The main materials of early popping candy are lactose, white granulated sugar and syrup, and the auxiliary additive are acid flavor agents (such as citric acid and malic acid), pigments (such as Allure Red, brilliant blue, etc.), essence (such as strawberry flavor, grape flavor edible essence, etc.). The early popping candy has a high sugar content and high calories itself, which has a significant impact on blood sugar levels and are prone to causing caries, making it difficult to spread widely. With the improvement of living standards, people's health awareness is becoming stronger and stronger. In order to adapt to the health trend, the lactose, the white granulated sugar, and the syrup are replaced by the isomaltitol rapidly as a main ingredient of the popping candy.

The existing technology discloses a sugarless popping candy and a preparation method thereof, including 98.4%-99.4% of isomaltitol, 0.5%-0.6% of carbon dioxide, and 0.1%-1% of additive. It provides a new generation of popping candy with isomaltitol as the main raw material, and the product is more healthy. However, the isomaltitol has a glass transition temperature of only 33° C., and will be soften when the storage and transportation temperatures exceeds 33° C., leading to the escape of carbon dioxide and the loss of popping sensation of the popping candy, which seriously affects the quality of the sugarless popping candy.

How to ensure the health and sugar-free of the popping candy while also increasing the glass transition temperature of the popping candy, and better retain carbon dioxide and maintain its popping sensation at higher storage and transportation temperatures, thus extending the product shelf life, has become an urgent technical problem to be solved.

### BRIEF SUMMARY OF THE INVENTION

In order to solve the above technical problem, the present application provides a sugarless popping candy and a preparation method thereof.

In a first aspect, the present application provides a sugarless popping candy, including the following components by mass percentage:
40%-79% of isomaltitol;
20%-40% of refined sugarless polyglucose;
0.5%-0.7% of carbon dioxide;
0%-20% of maltitol; and
0%-1.0% of additive.

In the above technical solution, the refined sugarless polyglucose is treated through ultrafiltration membrane to remove glucose to below 0.5% to achieve a sugarless treatment. Therefore, isomaltitol and refined sugarless polyglucose are sugarless and will not be decomposed into sugar after boiling, which conforms to the healthy and sugarless characteristics of sugarless popping candy. Refined sugarless polyglucose has a high glass transition temperature and does not change color when boiled at 150° C. Therefore, addition of refined sugarless polyglucose can increase the glass transition temperature of the popping candy, such that the prepared sugarless popping candy also have a high glass transition temperature and does not change color when boiled at 150° C. Furthermore, the refined sugarless polyglucose has low moisture absorption and is not easy to absorb water, so that it difficult for the prepared sugarless jump sugar to absorb water at high storage and transportation temperatures, thereby maintaining its surface stress and preventing carbon dioxide from escaping. The high glass transition temperature and low moisture absorption of the refined sugarless polyglucose enable the prepared sugarless jump sugar to retain carbon dioxide and maintain its popping sensation at higher storage and transportation temperatures. The sugarless popping candy obtained by mixing the isomaltitol and the refined sugarless polyglucose and then injecting carbon dioxide forms a hard sugar shape after melting, does not form a powder shape, and has a certain stress, which can prevent carbon dioxide from escaping, thus ensuring the popping sensation of the sugarless popping candy. Further, the maltitol has a low calorie content and a certain sweetness, and can also be used as a substitute for lactose, white granulated sugar, syrup, and other additive as the main materials for the sugarless popping candy. The glass transition temperature of the prepared sugarless popping candy can be increased to a certain extent. However, the maltitol has a certain moisture absorption, so addition of a small amount of maltitol can further increase the glass transition temperature of the finished popping candy without affecting its surface stress, so that the carbon dioxide is not easy to escape.

In summary, the sugarless popping candy produced by mixing the isomaltitol, the refined sugarless polydextrose, and the maltitol can not only ensure the health and sugarless of popping candy, but also increase the glass transition temperature of the popping candy, and retain the carbon dioxide at higher storage and transportation temperatures, thus maintaining the popping sensation, and extending the shelf life of the products.

In some embodiments, a sugarless popping candy includes the following components by mass percentage:
49%-69.5% of isomaltitol;
25%-35% of refined sugarless polyglucose;
0.5%-0.6% of carbon dioxide;
4%-15% of maltitol; and
0%-1.0% of additive.

After optimizing the proportion of raw materials mentioned above, the popping sensation of the sugarless popping candy is further improved.

In some embodiments, the additive is one or more selected from the group consisting of natural menthol, essence or spice, mogroside and natural pigment.

By adding the above additive to the popping candy, the popping candy can have different colors and flavors, meeting the taste needs of more people, without affecting its own characteristics and popping sensation.

In a second aspect, the present application discloses a preparation method for a sugarless popping candy, including the following steps:
(1) weighing the isomaltitol, the refined sugarless polyglucose, the maltitol, and the additive;
(2) mixing the isomaltitol, the refined sugarless polyglucose, the maltitol, and the additive weighed in step (1) uniformly to obtain a mixture;
(3) adding deionized water to the mixture of step (2) while heating and stirring until the mixture is completely dissolved to form a syrup, and filtering the syrup;
(4) boiling a filtered syrup at a temperature of 145° C.-155° C., and performing a vacuum dehydration with a vacuum degree of −0.04-−0.09 MPa;
(5) stirring and charging carbon dioxide into a vacuum dehydrated syrup, with an charging pressure of 3.0-4.5 MPa, for 5-15 minutes, to obtain an inflated syrup;
(6) cooling and molding the inflated syrup, with a cooling period of 4-6 hours and a molding pressure of 3.0-4.0 MPa, to obtain a blocky sugarless popping candy;
(7) crushing and sieving the blocky sugarless popping candy obtained in step (6) to obtain a granular sugarless popping candy; and
(8) performing a quality inspection and sealed packaging the granular sugarless popping candy obtained in step (6).

By using the above preparation method, the syrup can be made into a hard sugar shape, and is not easily to be powdery. The rate of finished products can be improved. The interior of the prepared sugarless popping candy can be filled with more carbon dioxide, and the carbon dioxide is not easy to escape. Therefore, the obtained popping candy have a strong popping sensation and a good taste.

In some embodiments, in step (3), a mass ratio of the mixture to the deionized water is 7:(1-1.5).

After mixing the mixture with the deionized water by the above mass ratio, not only can the mixture be completely dissolved, but also a syrup with moderate viscosity can be formed. The syrup has a good fluidity and is convenient for subsequent filtering, boiling, and dehydration, then a popping candy with good morphology is formed, which facilitate the subsequent charging.

In some embodiments, in step (4), a water content of the syrup after the vacuum dehydration is less than 2.0%.

The dehydrated syrup has less moisture and an increased viscosity, which facilitate charging more carbon dioxide into the syrup under charging pressure, so that the syrup contain more carbon dioxide and less prone to loss the carbon dioxide, thereby increasing the popping sensation of the popping candy.

In some implementation schemes, in step (7), a sieve used for sieving is 4-30 mesh.

In the above technical solution, by using above sieve of 4-30 mesh, a uncomfortable feeling will not be generated due to too large particles, and no popping sensation will not be generated due to too small particles.

In summary, the present application can achieve at least one of the following beneficial technical effects:
1. In the present application, a mixture of isomaltitol and refined sugarless polyglucose are adopted as the main raw materials for popping candy. The sugarless popping candy produced by mixing the isomaltitol and the refined sugarless polydextrose can not only ensure the health and sugarless of popping candy, but also increase the glass transition temperature of the popping candy, and retain the carbon dioxide at higher storage and transportation temperatures, thus maintaining the popping sensation, and extending the shelf life of the products.
2. In the present application, a small amount of maltitol is added to the raw material of the popping candy. A small amount of maltitol can further increase the glass transition temperature of the finished popping candy without affecting its surface stress, so that the carbon dioxide is not easy to escape.

### DETAILED DESCRIPTION

The present application is a further described in detail in combination with the examples and comparative examples hereinafter.

The refined sugarless polyglucose used in the following examples and comparative examples is obtained by dissolving commercially available ordinary polyglucose with a sugar content of about 3% in deionized water and performing ultrafiltration to remove sugar. The polyglucose with a sugar content below 0.5% is obtained, which meets the requirements of sugarless polyglucose, and is referred to be refined sugarless polyglucose.

Other raw materials used in the examples and comparative examples are commercially available.

### Example 1

(1) Weighing 6.945 kg of isomaltitol and 3 kg of refined sugarless polyglucose;
(2) mixing the raw materials weighed in step (1) uniformly to obtain a mixture;
(3) adding the mixture of step (2) and 1.42 kg of deionized water to a hot melt reactor for heating and dissolution until the mixture is completely dissolved to form a syrup, and then filtering the syrup using a 40 mesh filter screen;
(4) transporting a filtered syrup in a boiling equipment for candy boiling at a temperature of 150° C., and performing a vacuum dehydration at a vacuum degree of −0.07 MPa;
(5) transferring a vacuum dehydrated syrup to a stirring reactor, stirring and charging 0.055 kg of carbon dioxide into the vacuum dehydrated syrup, with an charging pressure of 3.8 MPa, for 10 minutes, to obtain an inflated syrup;
(6) transporting the inflated syrup to a cooling pipeline for cooling and molding, with a molding pressure of 3.5 MPa. Water circulation is used for cooling, and the cooling period is 5 hours; then placing a loading truck directly below a discharge port, opening a valve for discharging, to obtain a blocky sugarless popping candy;
(7) crushing the blocky sugarless popping candy obtained in step (6) roughly and placing the crushed sugarless popping candy on a rotary vibrating screen to obtain coarse particular popping candy, then discarding the fine powder, to obtain a moderate size popping candy corresponding to a mesh number of 15;
(8) performing a quality inspection and sealed packaging the granular sugarless popping candy obtained in step (7) after passing the quality inspection.

### Example 2

This example was same as Example 1 except that, in step (1), 4.945 kg of isomaltitol, 3 kg of refined sugarless polyglucose, and 2 kg of maltitol were weighed.

### Example 3

This example was same as Example 1 except that, in step (1), 6.91 kg of isomaltitol, 3 kg of refined sugarless polydextrose, 0.01 kg of natural menthol, 0.015 kg of essence and flavor, and 0.01 kg of mogroside were weighed.

### Example 4

This example was same as Example 1 except that, in step (1), 6.9146 kg of isomaltosol, 3 kg of refined sugarless polydextrose, 0.020 kg of essence and flavor, 0.0004 kg of carmine natural pigment, and 0.01 kg of mogroside were weighed.

### Example 5

This example was same as Example 1 except that, in step (1), 6.9146 kg of isomaltosol, 3 kg of refined sugarless polydextrose, 0.020 kg of jasmine tea flavor essence, 0.0004 kg of natural pigment, and 0.01 kg of mogroside were weighed.

### Example 6

This example was same as Example 2 except that, in Step (1), 4 kg of isomaltitol, 4 kg of refined sugarless polyglucose, and 1.93 kg of maltitol were weighed, and in Step (5), 0.07 kg of carbon dioxide was charged.

### Example 7

This example was same as Example 2 except that, in Step (1), 7.9 kg of isomaltitol, 2 kg of refined sugarless polyglucose, and 0.05 kg of maltitol were weighed, and in Step (5), 0.05 kg of carbon dioxide was charged.

### Example 8

This example was same as Example 2 except that, in Step (1), 6 kg of isomaltitol, 3.5 kg of refined sugarless polyglucose, and 0.44 kg of maltitol were weighed, and in Step (5), 0.06 kg of carbon dioxide was charged.

### Example 9

This example was same as Example 2 except that, in step (1), 6.5 kg of isomaltitol, 2.5 kg of refined sugarless polyglucose, and 0.945 kg of maltitol were weighed.

### Example 10

This example was same as Example 1 except that, in step (3), 2.131 kg of deionized water was added.

### Example 11

This example was same as Example 1 except that, in step (3), 0.71 kg of deionized water was added.

### Example 12

This example was same as Example 1 except that, in step (3), 2.84 kg of deionized water was added.

### Example 13

This example was same as Example 1 except that, in step (7), the mesh number of the screen was 4.

### Example 14

This example was same as Example 1 except that, in step (7), the mesh number of the screen was 30.

### Comparative Example 1

This Comparative example was same as Example 1 except that, in step (1), 9.945 kg of maltitol was weighed.

### Comparative Example 2

This Comparative example was same as Example 1 except that, in step (1), 4.9725 kg of isomaltitol and 4.9725 kg of maltitol were weighed.

### Comparative Example 3

This Comparative example was same as Example 1 except that, in step (1), 6.9615 kg of isomaltitol and 2.9835 kg of oligofructose were weighed.

### Comparative Example 4

This Comparative example was same as Example 1 except that, in step (1), 9.945 kg of isomaltitol was weighed.

### Comparative Example 5

This Comparative example was same as Example 1 except that, in step (1), 6.9615 kg of isomaltitol and 2.9835 kg of maltitol were weighed.

### Comparative Example 6

This Comparative example was same as Example 1 except that, in step (1), 1.4918 kg of refined sugarless polyglucose and 8.4532 kg of isomaltitol were weighed.

### Comparative Example 7

This Comparative example was same as Example 1 except that, in step (1), 1.4918 kg of refined sugarless polyglucose, 1.989 kg of maltitol, and 6.4642 kg of isomaltitol were weighed.

### Comparative Example 8

This Comparative example was same as Example 1 except that, in step (1), 9.945 kg of refined sugarless polyglucose was weighed.

### Comparative Example 9

Comparative example 9 is a commercially available popping candy.

### Comparative Example 10

This Comparative example was same as Example 1 except that, in step (4), the candy boiling temperature was 120° C., and then a vacuum dehydration was performed with a vacuum degree of −0.02 MPa.

### Comparative Example 11

This Comparative example was same as Example 1 except that, in step (5), the charging pressure was 2 MPa and the charging period was 18 minutes;

### Performance Testing

Two groups of sugarless popping candy prepared by the above examples and comparative examples were tested. One group was stored at 40° C. for one month and tested for the popping sensation, and the shape was observed within this one month. The other group was directly tested for the popping sensation. The test results were summarized as follows:

TABLE 1
Performance and popping sensation of sugarless popping
candy of Examples 1-14 and Comparative examples 1-11

| | | | | Glass transition | Popping sensation after |
|---|---|---|---|---|---|
| Serial | Performance of the | | Popping | temperature | 1 month of storage at |
| number | finished popping candy | Moisture | sensation | (° C.): | 40° C. |
| Example 1 | A popping candy was | <2% | 9.0 | 47 | 8.7 |
| | formed, with excellent | | | | |
| | performance | | | | |
| Example 2 | A popping candy was | <2% | 9.2 | 47.3 | 9.3 |
| | formed, with excellent | | | | |
| | performance | | | | |
| Example 3 | A popping candy was | <2% | 9.3 | 47.5 | 9.3 |
| | formed, with excellent | | | | |
| | performance | | | | |
| Example 4 | A popping candy was | <2% | 9.3 | 47.6 | 9.4 |
| | formed, with excellent | | | | |
| | performance | | | | |
| Example 5 | A popping candy was | <2% | 9.2 | 47.5 | 9.3 |
| | formed, with excellent | | | | |
| | performance | | | | |
| Example 6 | A popping candy was | <2% | 8.9 | 47 | 8.8 |
| | formed, with excellent | | | | |
| | performance | | | | |
| Example 7 | A popping candy was | <2% | 9.1 | 47.2 | 9.0 |
| | formed, with excellent | | | | |
| | performance | | | | |
| Example 8 | A popping candy was | <2% | 10.0 | 48 | 9.9 |
| | formed, with excellent | | | | |
| | performance | | | | |
| Example 9 | A popping candy was | <2% | 9.8 | 47.9 | 9.6 |
| | formed, with excellent | | | | |
| | performance | | | | |
| Example 10 | A popping candy was | <2% | 9.1 | 47.1 | 8.9 |
| | formed, with excellent | | | | |
| | performance | | | | |
| Example 11 | A popping candy was | <2% | 8.6 | 46.9 | 8.1 |
| | formed, with large | | | | |
| | amount of gas hole in | | | | |
| | the candy body | | | | |
| Example 12 | A popping candy was | <2% | 8.5 | 46.7 | 8.0 |
| | formed | | | | |
| Example 13 | A popping candy was | <2% | 9.0 | 46.5 | 8.1 |
| | formed | | | | |
| Example 14 | A popping candy was | <2% | 9.2 | 46.6 | 9.0 |
| | formed | | | | |
| Comparative | A popping candy | >2% | / | / | / |
| example 1 | cannot be formed | | | | |
| Comparative | A popping candy was | <2% | 4.8 | 37 | After 1 day of storage at |
| example 2 | formed | | | | 40° C., the popping |
| | | | | | sensation was |
| | | | | | completely disappeared |
| Comparative | A popping candy | >2% | / | / | / |
| example 3 | cannot be formed, and | | | | |
| | the raw materials were | | | | |
| | charred and carbonized | | | | |
| Comparative | A popping candy was | <2% | 8.9 | 33 | After 1 day of storage at |
| example 4 | formed | | | | 40° C., the popping |
| | | | | | candy was totally caked |
| | | | | | and the popping |
| | | | | | sensation was seriously |
| | | | | | lost, and after 5 days of |
| | | | | | storage at 40° C., the |
| | | | | | popping sensation was |
| | | | | | completely lost |
| Comparative | A popping candy was | <2% | 6.5 | 38 | After 1 day of storage at |
| example 5 | formed | | | | 40° C., the popping |
| | | | | | candy was totally caked |
| | | | | | and the popping |
| | | | | | sensation was seriously |
| | | | | | lost, and after 5 days of |
| | | | | | storage at 40° C., the |
| | | | | | popping sensation was |
| | | | | | completely lost |
| Comparative | A popping candy was | <2% | 8.7 | 38.6 | After 3 days of storage |
| example 6 | formed | | | | at 40° C., the popping |
| | | | | | sensation was |
| | | | | | significantly weakened, |
| | | | | | and after 8 days of |
| | | | | | storage at 40° C., the |
| | | | | | popping sensation was |
| | | | | | completely lost |
| Comparative | A popping candy was | <2% | 9.1 | 39.1 | After 10 days of storage |
| example 7 | formed | | | | at 40° C., the popping |
| | | | | | sensation was |
| | | | | | significantly weakened, |
| | | | | | and after 15 days of |
| | | | | | storage at 40° C., the |
| | | | | | popping sensation was |
| | | | | | completely lost |
| Comparative | A popping candy was | <2% | 8.5 | 39.4 | After 18 days of storage |
| example 8 | formed | | | | at 40° C., the popping |
| | | | | | sensation was |
| | | | | | significantly weakened, |
| | | | | | and after 25 days of |
| | | | | | storage at 40° C., the |
| | | | | | popping sensation was |
| | | | | | completely lost |
| Comparative | A commercially | / | 10.0 | 50 | 9.7 |
| example 9 | available popping | | | | |
| | candy containing sugar | | | | |
| Comparative | A popping candy | >3% | / | / | / |
| example 10 | cannot be formed | | | | |
| Comparative | A popping candy | >2% | / | / | / |
| example 11 | cannot be formed | | | | |

Referring to the Examples 1-9, the Comparative examples 1-9, and Table 1, it can be seen that, in Example 1, only the isomaltitol and the refined sugarless polyglucose were added as the raw materials, the popping candy prepared already had a good popping sensation, and still maintained a good popping sensation after being stored at 40° C. for one month. In Example 2, after the maltitol was added, the popping sensation was increased, especially after being stored at 40° C. for one month, the popping sensation increased from 8.7 in Example 1 to 9.3, indicating that the maltitol can improve the popping sensation of the sugarless popping candy of the present application to some extent. In Examples 3-5, other additive were added, which not only improved the taste of the popping candy, but also increased the popping sensation. In Examples 6-9, by adjusting the addition amounts of the isomaltitol, the refined sugarless polyglucose, the carbon dioxide, and the maltitol, it can be found that, when the addition amount of the maltitol was not high, the popping sensation of the finished popping candy and the popping sensation after being stored at 40° C. for one month were significantly improved, especially in Examples 8-9; when the mass percentage of the maltitol added was around 4-10%, a better popping sensation was obtained, indicating that the ratio of the isomaltitol, the refined sugarless polyglucose, the carbon dioxide, and the maltitol has a significant impact on the popping sensation of the finished sugarless popping candy. In Comparative example 1, only the maltitol was added as the raw material, but a popping candy cannot be formed, because the maltitol has a strong moisture absorption and the moisture content of the popping candy produced was greater than 2%. In Comparative example 2, equal mass of isomaltitol and maltitol were used as raw materials, although a popping candy could be formed, the popping sensation was only 4.8, and the popping sensation completely disappeared after being stored at 40° C. for 1 day. In Comparative example 3, the isomaltonol and oligofructose were used as raw materials, it was found that a popping candy could not be formed at all, and the raw materials had completely charred and carbonized during the candy boiling process, making it impossible to boil at around 150° C. In comparative example 4, only the isomaltitol was used as the raw material. Although the popping sensation reached 8.9 when the popping candy was just prepared, the popping candy was totally caked and the popping sensation was seriously lost after being stored at 40° C. for 1 day, and the popping sensation was completely lost after being stored at 40° C. for 5 days. In Comparative example 5, a mixture of 70% mass percentage of isomaltitol and 29.45% mass percentage of maltitol were used to prepare the popping candy. However, the popping candy was totally caked and the popping sensation was seriously lost after being stored at 40° C. for 1 day, and the popping sensation was completely lost after being stored at 40° C. for 5 days. In Comparative example 6, 85% mass percentage of isomaltitol and 14.45% mass percentage of refined sugarless polyglucose were used as raw materials. The popping sensation was 8.7 when the popping candy was just prepared, but the popping sensation was significantly weakened after being stored at 40° C. for 3 days, and the popping sensation was completely lost after being stored at 40° C. for 8 days. In Comparative Example 7, 65% mass percentage of isomaltitol, 14.45% mass percentage of refined sugarless polyglucose, and 20% mass percentage of maltitol were used as raw materials. The popping sensation was 9.1 when the popping candy was just prepared, but the popping candy was caked and the popping sensation was significantly weakened after being stored at 40° C. for 10 days, and the popping sensation was completely lost after being stored at 40° C. for 15 days. In Comparative example 8, only the refined sugarless polyglucose was used as raw material, the popping sensation was 8.5 when the popping candy was just prepared, the popping sensation was significantly weakened after being stored at 40° C. for 18 days, and the popping sensation was completely lost after being stored at 40° C. for 25 days. Comparative example 9 was a commercially available popping candy with excellent popping sensation. From the above test results, it was indicated that, adding only one of isomaltitol, refined sugarless polyglucose, and maltitol as raw materials, or adding other sugars such as oligofructose as raw materials, the prepared popping candies had a popping sensation when they were just prepared. However, after being stored at 40° C., the prepared popping candies were quickly caked and lost the popping sensation, because the glass transition temperature of the sugarless popping candy made with only isomaltitol in comparative example 4 was about 33° C., storage at 40° C. would cause caking and escape of carbon dioxide, then loss of popping sensation. In Comparative example 5, the popping candy was made from isomaltitol and maltitol in a certain proportion, with a glass transition temperature of about 38° C. Therefore, storage at 40° C. will also result in a lose of the popping sensation. Comparative example 4 and Comparative example 5 were the situations of two existing technologies. In the present application, the refined sugarless polyglucose was added, which increases the glass transition temperature of the sugarless popping candy while maintaining the sugarless characteristic. In Example 8, the glass transition temperature of the sugarless popping candy reached 48° C., so the popping sensation was substantially not changed, and was still adequate after being stored at 40° C. for one month.

In summary, the sugarless popping candy prepared by the technical solution of the present application not only ensures the health and sugarless of the popping candy, but also has a popping sensation equivalent to that of the commercially available popping candy containing sugar. Compared with the sugarless popping candy in the existing technology, the glass transition temperature of the popping candy is also increased, and the carbon dioxide can be better retained at higher temperatures, maintaining the popping sensation, and extending the product shelf life. The reason is that the combination of the isomaltitol, the refined sugarless polyglucose, and the maltitol allows the resultant syrup to meet the characteristics of the popping candy, such as high glass transition temperature, melting into hard candy, sugarless and not decomposing to be sugar after boiling, no color change when boiled at 150° C., low moisture absorption, and certain stress after becoming hard candy. Therefore, sugarless popping candy with excellent characteristics can be prepared.

Referring to Examples 10-14, Comparative examples 10-11 and Table 1, it can be seen that, the preparation method of the popping candy has an impact on the performance of the popping candy. In Examples 10-12, different amount of deionized water was added. In Example 11, less deionized water was added, although a popping candy can be formed, the syrup was too viscous and more gas holes generated during charging carbon dioxide, resulting in less carbon dioxide remaining in the candy and reduced popping sensation. In Example 12, addition of excessive deionized water resulted in more time and increased costs in the subsequent candy boiling and dehydration process. In Comparative example 10, the temperature for boiling was low, and the vacuum degree for vacuum dehydration was low as well, so the water in the syrup had not been completely removed and a popping candy cannot be formed. In Comparative example 11, the charging pressure was low and the charging period was short, resulting in insufficient gas filling into the candy, greatly reducing the popping sensation of the finished product. Therefore, using the preparation method for the sugarless popping candy disclosed in the present application, a sugarless popping candy with good properties, good popping sensation, and good eating experience can be obtained.

The above are all preferred embodiments of the present application and do not intent to limit the protection scope of the present application. Therefore, any equivalent changes made based on the structure, shape, and principle of the present application should fall within the scope of the present application.

What is claimed is:

1. A sugarless popping candy, comprising the following components by mass percentage:
40%-79% of isomaltitol;
20%-40% of refined sugarless polyglucose;
0.5%-0.7% of carbon dioxide;
0%-20% of maltitol; and
0%-1.0% of additive.

2. A sugarless popping candy according to claim 1, wherein the sugarless popping candy comprises the following components by mass percentage:
49%-69.5% of the isomaltitol;
25%-35% of the refined sugarless polyglucose;
0.5%-0.6% of the carbon dioxide;
4%-15% of the maltitol; and
0%-1.0% of the additive.

3. A sugarless popping candy according to claim 1, wherein the additive is one or more selected from the group consisting of natural menthol, essence or spice, mogroside and natural pigment.
